(19) United States
(12) Patent Application Publication
(10) Pub. No.: US 2011/0225648 A1
(43) Pub. Date: Sep. 15, 2011

(54) METHOD AND APPARATUS FOR REDUCING THE USE OF INSECURE PASSWORDS

(75) Inventor: Girish Mallenahally Channakeshava, Bangalore (IN)

(73) Assignee: INTUIT INC., Mountain View, CA (US)

(21) Appl. No.: 12/724,417

(22) Filed: Mar. 15, 2010

(51) Int. Cl. G06F 21/00

(52) U.S. Cl. 726/18

(57) ABSTRACT

One embodiment of the present invention provides a system for reducing the use of insecure passwords. During operation, the system receives a login request at a computer system, wherein the login request includes a username and a password. Next, the system saves the password to an attempted password list, wherein the attempted password list includes passwords that have been attempted during login. The system then receives a password change request, wherein the password change request includes a username and a new password. Next, the system determines whether the new password is a member of the attempted password list. If so, the system rejects the password change request. However, if not, the system processes the password change request.

### BACKGROUND

1. Related Art

Computer systems typically use security measures to protect sensitive data. These security measures include user-authentication techniques to help ensure that only authorized users are granted access to the computer systems. For example, requiring a user ID and password to access these computer systems is one of the most common user-authentication techniques.

In order to reduce the risk of successful password cracking, system administrators typically establish password policies that require passwords to meet certain complexity requirements. These requirements typically include a minimum length, inclusion of certain types of characters, and restrictions against using dictionary terms. Increasing the complexity of the requirements makes the computer systems more secure by eliminating passwords that are easy for a hacker to guess, but also adds to the frustration of the users.

2. Summary

One embodiment of the present invention provides a system for reducing the use of insecure passwords. During operation, the system receives a login request at a computer system, wherein the login request includes a username and a password. Next, the system saves the password to an attempted password list, wherein the attempted password list includes passwords that have been attempted during login. The system then receives a password change request, wherein the password change request includes a username and a new password. Next, the system determines whether the new password is a member of the attempted password list. If so, the system rejects the password change request. If not, the system processes the password change request.

In some embodiments of the present invention, the system saves the password to the attempted password list only if the login request fails.

In some embodiments of the present invention, the system saves a hash of the password in the attempted password list instead of saving the actual password. In these embodiments, the system determines whether the new password is a member of the attempted password list by determining if a hash of the new password is a member of the attempted password list.

In some embodiments of the present invention, saving the password to the attempted password list further comprises determining if a session with one or more unsuccessful login attempts results in a successful login. If so, the system does not add passwords for the unsuccessful login attempts to the attempted password list.

In some embodiments of the present invention, the system removes passwords from the attempted password list after a pre-determined amount of time.

In some embodiments of the present invention, the system removes passwords from the attempted password list after the attempted password list reaches a pre-determined length.

In some embodiments of the present invention, the attempted password list is maintained per user.

In some embodiments of the present invention, determining if the new password is a member of the attempted password list further comprises determining if a substring of the new password is a member of the attempted password list.

In some embodiments of the present invention, determining if the new password is a member of the attempted password list further comprises determining if the new password is a substring of a member of the attempted password list.

In some embodiments of the present invention, determining if the new password is a member of the attempted password list further comprises determining if a variation of the new password is a member of the attempted password list.

### BRIEF DESCRIPTION OF THE FIGURES

FIG. 1 illustrates a computing environment in accordance with an embodiment of the present invention.

FIG. 2 illustrates a system in accordance with an embodiment of the present invention.

FIG. 3 presents a flow chart illustrating the process of storing attempted passwords in accordance with an embodiment of the present invention.

FIG. 4 presents a flow chart illustrating the process of performing a password change operation in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### OVERVIEW

One embodiment of the present invention provides a system for reducing the use of insecure passwords. During operation, the system receives a login request at a computer system, wherein the login request includes a username and a password. Next, the system saves the password to an attempted password list, wherein the attempted password list includes passwords that have been attempted during login. The system then receives a password change request, wherein the password change request includes a username and a new password. Next, the system determines whether the new password is a member of the attempted password list. If so, the system rejects the password change request. If not, the system processes the password change request.

Essentially, the system keeps track of every password attempted, and prevents these passwords from being selected by a user. If a password has been attempted at least once, there is a higher probability that the password may be attempted again in the future. By eliminating these higher-risk passwords from the system, the system will be less prone to intrusion from password crackers.

For example, many users pick relatively simple passwords based on simple combinations of common data. A user with a child named “Penny” might pick the password “pennylove,” and simply append a different term each time he or she is forced to change the password. In this example, if a hacker discovers that the user has a child named “Penny,” the hacker might use the term “penny” as a seed for various password cracking attempts. If the hacker repeatedly attempts to crack the user's password, and the user changes his or her password to one of the hacker's attempted passwords, such as “penny123,” then the probability of the hacker gaining access to the user's account is much greater. In this example, embodiments of the present invention will actively block the user from changing his or her password to a relatively insecure password that has been previously attempted on the system.

In some embodiments of the present invention, the system saves the password to the attempted password list only if the login request fails. Note that it would require fewer system resources to add a valid password to the attempted password list during a password change operation than to try and save the valid password to the attempted password list during every login attempt. Also note that in some embodiments the system might not save a valid password to the attempted password list at all.

In some embodiments of the present invention, the system saves a hash of the password in the attempted password list instead of saving the actual password. In these embodiments, the system determines whether the new password is a member of the attempted password list by determining if a hash of the new password is a member of the attempted password list.

Note that using a hash of the password rather than the actual password provides an extra layer of security. If a hacker successfully retrieves the attempted password list from the system, the hacker will be unable to convert the hashes back to the original passwords.

In some embodiments of the present invention, saving the password to the attempted password list further comprises determining if a session with one or more unsuccessful login attempts results in a successful login. If so, the system does not add passwords for the unsuccessful login attempts to the attempted password list.

For example, on occasion users mistype their passwords while authenticating to the system. The mistyped passwords in these unsuccessful login attempts do not necessarily represent a higher-risk password. If a particular session results in a successful login, then any attempt in the same session prior to the successful login is most likely the result of the user mistyping their password.

In some embodiments of the present invention, the system removes passwords from the attempted password list after a pre-determined amount of time, while in other embodiments, the system removes passwords from the attempted password list after the attempted password list reaches a pre-determined length. Note that these embodiments can be configuration options implemented by an administrator.

In some embodiments of the present invention, the attempted password list is maintained per user. Some user accounts might pose more risk for hacking than other user accounts, so it may be advantageous to maintain the attempted password list per user. For example, each login attempt requires a username and a password. A username such as “Sheldon” is more likely to be attempted by a random password cracker than a username like “scooper187.”

In some embodiments of the present invention, determining if the new password is a member of the attempted password list further comprises determining if a substring of the new password is a member of the attempted password list. For example, if a user attempts to change their password to “bazinga5,” and “bazinga” exists in the attempted password list, then the system would force the user to choose a different password.

In some embodiments of the present invention, determining if the new password is a member of the attempted password list further comprises determining if the new password is a substring of a member of the attempted password list. For example, if a user attempts to change their password to “bazinga,” and “bazinga123” exists in the attempted password list, then the system would force the user to choose a different password.

In some embodiments of the present invention, determining if the new password is a member of the attempted password list further comprises determining if a variation of the new password is a member of the attempted password list. For example, if a user attempts to change their password to “bazinga187,” and “bazinga123” exists in the attempted password list, then the system would force the user to choose a different password.

Note that in some embodiments of the present invention, the system may use lookup tables to assign equivalencies among different characters. For example, the system may determine that the characters “3” and “e” are equivalent, and the characters “o” and “0” are equivalent. In this example, the password “leonard” is a member of the attempted password list, then “l3onard,” “le0nard,” and “l30nard” would not be allowed.

Furthermore, some embodiments provide a system that is case-insensitive. For example, “wolowitz5,” “Wolowitz5,” “w0l0witz5,” and “wOlOwItZ5” would all be deemed “equivalent,” and the existence of one in the attempted password list would render all of these variations unusuable.

Computing Environment

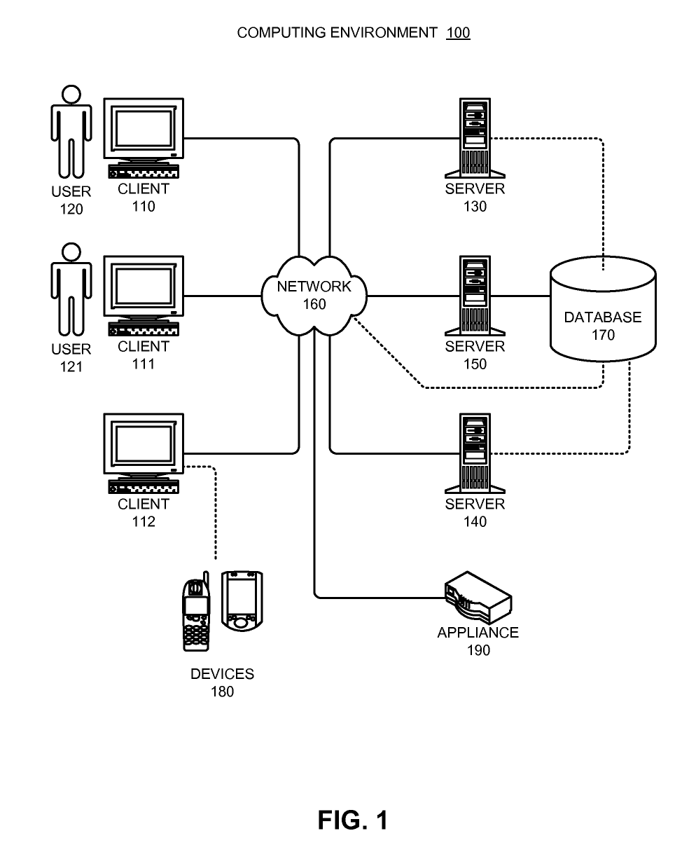

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, devices 180, and appliance 190.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, servers 130-150 can generally include any node on a network including a mechanism for servicing requests from a client for computational and/or data storage resources. Servers 130-150 can participate in an advanced computing cluster, or can act as stand-alone servers. In one embodiment of the present invention, server 140 is an online “hot spare” of server 150.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), smart-phones, personal music players (such as MP3 players), gaming systems, digital cameras, video cameras, portable storage media, or any other device that can be coupled to the client. Note that, in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Note that different embodiments of the present invention may use different system configurations, and are not limited to the system configuration illustrated in computing environment 100. In general, any device that is capable of supporting user authentication via a username/password pair may incorporate elements of the present invention.

System

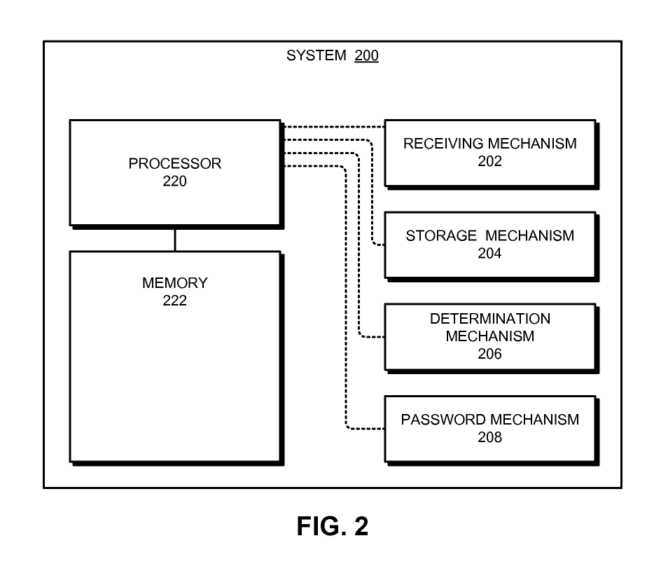

FIG. 2 illustrates a system 200 in accordance with an embodiment of the present invention. As illustrated in FIG. 2, system 200 can comprise server 150, database 170, appliance 190, client 110, devices 180, or any combination thereof. System 200 can also include receiving mechanism 202, storage mechanism 204, determination mechanism 206, password mechanism 208, processor 220, and memory 222.

In some embodiments of the present invention, system 200 is distributed across clients 110-112, servers 130-150, database 170, devices 180, appliance 190, and generally any other device coupled to network 160. In these embodiments, the attempted password list is stored in database 170, and is accessible by any device coupled to network 160. If user 120 attempts to gain access to user 121′s account by using client 110 to access server 150, each attempted password that user 120 tries is stored in the attempted password list in database 170. If user 121 subsequently tries to change his or her password via devices 180 to a password that user 120 attempted, the system will query database 170, determine that the new password has been previously attempted, and force user 121 to pick a different password.

Storing Attempted Passwords

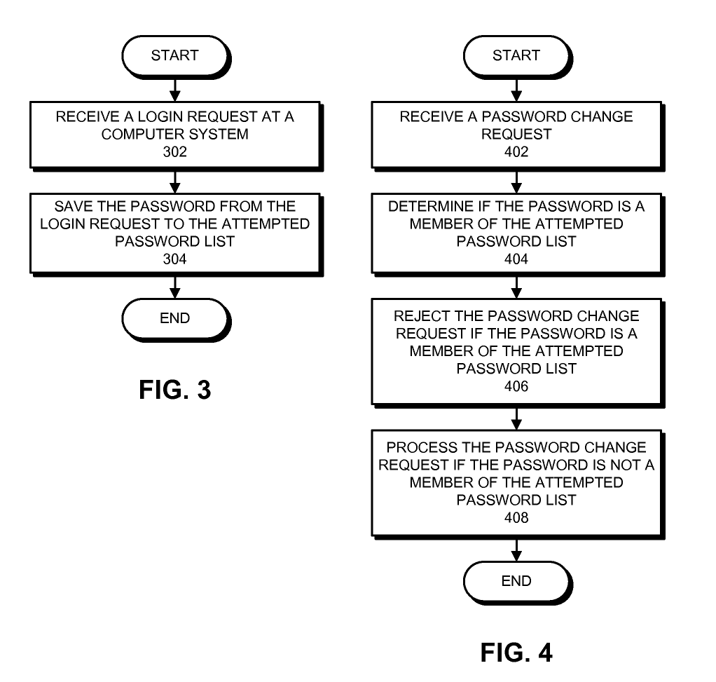

FIG. 3 presents a flow chart illustrating the process of storing attempted passwords in accordance with an embodiment of the present invention. During operation, receiving mechanism 202 receives a login request at a computer system, such as server 150 (operation 302). Note that the login request includes a username and a password. Next, storage mechanism 204 saves the password to an attempted password list (operation 304).

As described previously, the attempted password list includes passwords that have been attempted during login. The attempted password list may be saved locally, or may be saved in a centralized repository, such as database 170. In some embodiments of the present invention, server 150 may also keep a local cache of recently attempted passwords to facilitate enhanced security in a situation where database 170 may be temporarily unreachable.

Note that, in some embodiments of the present invention, the system may save a hash of the password instead of the password itself in the attempted password list. Optionally, any attempted passwords in a session that ultimately results in a successful login may not be added to the attempted password list.

Performing a Password Chance Operation

FIG. 4 presents a flow chart illustrating the process of performing a password change operation in accordance with an embodiment of the present invention. During operation, receiving mechanism 202 receives a password change request (operation 402). Note that the password change request includes a username and a new password.

Next, determination mechanism 206 determines whether the new password is a member of the attempted password list (operation 404). Optionally, this can include determining if a variation of the password is a member of the attempted password list, determining if a substring of the password is a member of the attempted password list, or determining if the password is a substring of a member in the attempted password list. Note that, as described previously, this can involve employing lookup tables of character equivalencies to determine if an “equivalent” password is a member of the attempted password list.

Next, password mechanism 208 rejects the password change request if the new password is a member of the attempted password list (operation 406). Finally, password mechanism 208 processes the password change request if the new password is not a member of the attempted password list (operation 408).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for reducing the use of insecure passwords, the method comprising:
receiving a login request at a computer system, wherein the login request includes a username and a password;
saving the password to an attempted password list, wherein the attempted password list includes passwords that have been attempted during login;
receiving a password change request, wherein the password change request includes a username and a new password;
determining if the new password is a member of the attempted password list;
if so, rejecting the password change request; and
if not, processing the password change request.

2. The computer-implemented method of claim 1, wherein saving the password to the attempted password list further comprises only saving the password to the attempted password list if the login request fails.

3. The computer-implemented method of claim 1:
wherein saving the password to the attempted password list involves saving a hash of the password in the attempted password list; and
wherein determining if the new password is a member of the attempted password list involves determining if a hash of the new password is a member of the attempted password list.

4. The computer-implemented method of claim 1, wherein saving the password to the attempted password list further comprises:
determining if a session with one or more unsuccessful login attempts results in a successful login; and
if so, not adding passwords for the unsuccessful login attempts to the attempted password list.

5. The computer-implemented method of claim 1, further comprising removing passwords from the attempted password list after a pre-determined amount of time.

6. The computer-implemented method of claim 1, further comprising removing passwords from the attempted password list after the attempted password list reaches a pre-determined length.

7. The computer-implemented method of claim 1, wherein the attempted password list is maintained per user.

8. The computer-implemented method of claim 1, wherein determining if the new password is a member of the attempted password list further comprises determining if a substring of the new password is a member of the attempted password list.

9. The computer-implemented method of claim 1, wherein determining if the new password is a member of the attempted password list further comprises determining if the new password is a substring of a member of the attempted password list.

10. The computer-implemented method of claim 1, wherein determining if the new password is a member of the attempted password list further comprises determining if a variation of the new password is a member of the attempted password list.

11. A computer-readable storage medium storing instructions that when executed by a computer cause the computer to perform a method for reducing the use of insecure passwords, the method comprising:
receiving a login request at a computer system, wherein the login request includes a username and a password;
saving the password to an attempted password list, wherein the attempted password list includes passwords that have been attempted during login;
receiving a password change request, wherein the password change request includes a username and a new password;
determining if the new password is a member of the attempted password list;
if so, rejecting the password change request; and
if not, processing the password change request.

12. The computer-readable storage medium of claim 11, wherein saving the password to the attempted password list further comprises only saving the password to the attempted password list if the login request fails.

13. The computer-readable storage medium of claim 11:
wherein saving the password to the attempted password list involves saving a hash of the password in the attempted password list; and
wherein determining if the new password is a member of the attempted password list involves determining if a hash of the new password is a member of the attempted password list.

14. The computer-readable storage medium of claim 11, wherein saving the password to the attempted password list further comprises:
determining if a session with one or more unsuccessful login attempts results in a successful login; and
if so, not adding passwords for the unsuccessful login attempts to the attempted password list.

15. The computer-readable storage medium of claim 11, wherein the method further comprises removing passwords from the attempted password list after a pre-determined amount of time.

16. The computer-readable storage medium of claim 11, wherein the method further comprises removing passwords from the attempted password list after the attempted password list reaches a pre-determined length.

17. The computer-readable storage medium of claim 11, wherein the attempted password list is maintained per user.

18. The computer-readable storage medium of claim 11, wherein determining if the new password is a member of the attempted password list further comprises determining if a substring of the new password is a member of the attempted password list.

19. The computer-readable storage medium of claim 11, wherein determining if the new password is a member of the attempted password list further comprises determining if the new password is a substring of a member of the attempted password list.

20. The computer-readable storage medium of claim 11, wherein determining if the new password is a member of the attempted password list further comprises determining if a variation of the new password is a member of the attempted password list.

21. An apparatus configured for reducing the use of insecure passwords, comprising:
a receiving mechanism configured to receive a login request at a computer system, wherein the login request includes a username and a password;
a storage mechanism configured to save the password to an attempted password list, wherein the attempted password list includes passwords that have been attempted during login;
wherein the receiving mechanism is further configured to receive a password change request, wherein the password change request includes a username and a new password;
a determination mechanism configured to determine if the new password is a member of the attempted password list;
a password mechanism configured to reject the password change request if the new password is a member of the attempted password list; and
wherein the password mechanism is further configured to process the password change request if the new password is not a member of the attempted password list.

22. The apparatus of claim 21, wherein the storage mechanism is further configured to save the password to the attempted password list if the login request fails.

23. The apparatus of claim 21:
wherein the storage mechanism is further configured to save a hash of the password in the attempted password list; and
wherein the determination mechanism is further configured to determine if a hash of the new password is a member of the attempted password list

24. The apparatus of claim 21, wherein saving the password to the attempted password list further comprises:
determining if a session with one or more unsuccessful login attempts results in a successful login; and
if so, not adding passwords for the unsuccessful login attempts to the attempted password list.
